(19) United States
(12) Patent Application Publication
(10) Pub. No.: US 2015/0225243 A1
(43) Pub. Date: Aug. 13, 2015

(54) PROCESS FOR PURIFICATION OF CARBON NANOTUBES

(71) Applicant: SAMSUNG SDI CO., LTD., Yongin-si (KR)

(72) Inventors: Kuanping Gong, Fremont, CA (US); Lijie Ci, Jinan (CN)

(21) Appl. No.: 14/608,123

(22) Filed: Jan. 28, 2015

Related U.S. Application Data
(60) Provisional application No. 61/937,405, filed on Feb. 7, 2014.

(51) Int. Cl. C01B 31/02

(52) U.S. Cl. CPC C01B 31/026

(57) ABSTRACT

A process for purifying carbon nanotubes includes mixing a fluid carrier with an oxidizing agent to form an oxidizing solution, and adding the oxidizing solution to a closed container such that the oxidizing solution makes up a fraction of the volume of the container. Carbon nanotubes containing transition metal nanoparticles and carbonaceous impurities are then added to the oxidizing solution to form a carbon nanotube slurry, and the slurry is heated at an elevated temperature not exceeding 110° C. to vaporize at least a portion of the oxidizing agent. Acid is then added to the heated carbon nanotube slurry to dissolve transition metal particles.

### CROSS-REFERENCE TO RELATED APPLICATION

This application claims priority to and the benefit of U.S. Provisional Patent Application No. 61/937,405, filed on Feb. 7, 2014, and titled PROCESS FOR PURIFICATION OF CARBON NANOTUBES, the entire content of which is incorporated herein by reference.

### TECHNICAL FIELD

The present disclosure is related to a method of purifying carbon nanotubes, and more particularly, to vapor processible purification of carbon nanotubes.

### BACKGROUND

Carbon nanotubes (CNTs) have many unique properties. Examples of such properties include being many-fold stronger than steel, harder than diamond, having electrical conductivity higher than copper, thermal conductivity higher than diamond, etc. However, obtaining high-purity CNTs for the desired application has been challenging. As-prepared CNTs are usually accompanied by a variety of impurities, such as graphite phase or amorphous phase carbon lumps, carbon particles (particles that are smaller than carbon lumps and that stick to the surface of individual carbon nanotubes), or catalytic metal particles. These impurities make purification an essential issue to be addressed in the manufacture of carbon nanotubes.

Considerable progress in the purification of CNTs has been made; and a number of purification methods including gas-phase chemical oxidation, liquid-phase chemical oxidation, electrochemical oxidation, mechanical and/or physical separation have been developed for obtaining CNTs with desired purity. For example, gas-phase oxidation involves using a pressurized oxidizing gas such as air, a Cl₂/H₂O/HCl mixture, an Ar/O₂/H₂O mixture, an O₂/SF₆/C₂H₂F₄ mixture, a H₂S/O₂ mixture, or steam to remove impurities based on their different tolerances to oxidation from an sp² carbon. However, the impurities in the CNTs may have insufficient contact with the oxidizing gas, which is particularly true for purifying a large amount of CNTs. This method is also ineffective toward metal catalysts in general, and those shielded by a carbon layer in particular. Hence, additional steps are required to complete the purification, providing a challenge to the use of this method for practical applications.

Liquid-phase oxidation utilizes a chemical mechanism similar to that of gas-phase oxidation, and often can operate under relatively mild conditions. Typical oxidizers include HNO₃, H₂O₂, H₂SO₄, KMnO₄, NaOH and mixtures thereof. H₂SO₄/HNO₃ mixture is an example. This process also has the limitation of insufficient exposure of samples to liquid oxidants. Additionally, liquid oxidants are often more powerful and attack both the CNTs and their impurities, which affects the selective removal of impurities. The environmental footprint of these liquid agents is an additional disadvantage of this method.

Electrochemical oxidation can remove impurities based on their relatively high sensitivity to potential polarization by voltammetric oxidation in alkali and acidic media. However, several difficulties arise upon targeting a large sample size: 1) the superhydrophobic surface of CNTs poses a challenge for the design of electrodes in terms of mass diffusion in most electrolytes; 2) a potential drop in bulk CNTs as a result of impedance might impede homogeneous purification of CNTs; and 3) electrochemical techniques need an electrode substrate (for electron shuttling) that is electrically conductive, chemically stable, and ideally, polarized. These intrinsic requirements, coupled with the redox inactivity of impurities such as amorphous carbon, limit the choices of electrode materials to achieve purification of the CNTs. Indeed, very few electrochemical methods have been reported to date that can promise practical applications for purifying CNTs.

Mechanical and/or physical purification is based on the difference in physical properties between the impurities and the CNTs. Typical methods include filtration, centrifugation, high-temperature annealing, magnetophoretic purification, supercritical fluid carbon dioxide extraction, mechanical ejection with hard inorganic particles, chromatography, and electrophoresis. Methods of this kind ideally preserve the nature of the CNTs while removing the impurities. However, mechanical and physical methods appear to be very slow and messy. In most cases, a complicated pre- or post-treatment of CNTs may be involved, for example, to achieve a good suspension in surfactants, or to eliminate additives. More importantly, impurities often interact with the CNTs very strongly by physical or chemical forces, so that the physical methodology alone cannot efficiently separate them from each other. Consequently, physical or mechanical methods are commonly combined with chemical processes in purifying CNTs in order maintain quality.

Delzeit et al. (U.S. Pat. No. 6,972,056) discloses a method that first exposes a carbon nanotube array with amorphous carbon and other residues to hydroxyls or hydrogen, produced from selected vapor or liquid sources such as H₂O or H₂O₂. The hydroxyls or hydrogen then react with the residues to produce partly or fully dissolved or hydrogenated or hydroxylated products that can be removed or separated from the CNT array. The hydroxyls or hydrogen are produced by heating, or by using an electromagnetic excitation signal with a selected frequency or range of frequencies to dissociate the selected vapor or liquid prior to reacting with impurities. In some embodiments, additional steps such as sonication are required to improve the efficiency. Since H₂O₂ is unstable and often dissociates to generate H₂O and O₂, and O₂ can burn off CNTs significantly under specific conditions, the method relies on inert gas to purge, high vacuum, and/or an additional repeated free-evacuation-thaw process to eliminate O₂. The concern of O₂ becomes even more serious when a harsh condition such as heating, UV-vis radiation, and sonication must be used to generate —OH. Also, as the disclosed method is aimed at in-situ purification of an array of CNTs, where the well-defined orientation of CNT arrays with metal impurities are most likely located at the bottom end and readily exposed to etching agents, this method may not work well with randomly-oriented CNTs.

R. Smalley et.al. (U.S. Pat. No. 7,494,639) discloses a method of purifying carbon nanotubes based on the chemistry of Fenton's Reagents. The method includes adding non-oxidizing mineral acid to an aqueous slurry of the carbon nanotubes containing Fe impurities to maintain a pH of 1 to 3, and adding H₂O₂ to the acidic slurry to create hydroxyl radicals through Fenton's chemistry. The reaction is carried out in liquid phase in which efficiency is not very high, and the process may need to be repeated several times to yield higher levels of purification.

Therefore, there is a desire for a faster, more efficient and effective method of purifying carbon nanotubes, and for a method of purifying carbon nanotubes without significantly altering the conjugated lattice of the CNTs.

### SUMMARY

Briefly, in embodiments of the present invention comprises, a process for vapor processible purification of carbon nanotubes includes providing a fluid carrier with a small amount of oxidizing agent in a closed container, adding CNTs containing transition metal nanoparticles and carbonaceous impurities into the fluid carrier to form a CNT slurry, and heating the CNT slurry to vaporize at least a fraction of the oxidizing agent at an elevated temperature not exceeding 110° C. for a selected amount of time. The transition metal nanoparticles are dissolved in the CNT slurry (and thereby removed) from the CNTs by adding an acid to the CNT slurry.

In some embodiments, the oxidizing agent comprises H₂O₂, which forms hydroxyl free radicals through a self-catalytic reaction with the transition metal nanoparticles. The H₂O₂ oxidizing agent is a relatively moderate oxidizer and dissociates kinetically slower under the operating conditions.

The vapor-based purification process inhibits damage to the CNTs while selectively removing transition metal nanoparticles and carbonaceous impurities from the CNTs. In addition to being non-invasive to the CNTs, the purification process according to embodiments of the invention is also effective in purifying randomly oriented CNTs as the starting material.

These and other aspects of embodiments of the invention will be more fully understood by reference to the following detailed description and the accompanying drawings.

### BRIEF DESCRIPTION OF THE DRAWINGS

FIG. 1 is a flowchart illustrating a process according to embodiments of the invention.

FIG. 2 is a schematic illustration of the glassware setup for vapor-based processing of DWNTs and the volume change of DWNT samples upon heating at about 80° C. to about 110° C.

FIG. 3A is a photograph of DWNTs having the dimensions 10.5 cm×0.5 cm (diameter×height) at ambient conditions, and FIG. 3B is a photograph showing the same DWNTs expanded to the full 3-liter flask upon heating.

FIG. 4 shows Thermogrametric curves for DWNTs before purification (dotted), and after purification in H₂O₂-vapor (solid) and HNO₃-vapor (dashed), respectively. The weight percent of the residues are numbered therein.

FIGS. 5A to 5D shows low- and high-magnification TEM images of DWNTs before (FIGS. 5A, 5B) and after (FIGS. 5C, 5D) processing in H₂O₂ vapor.

FIG. 6 shows Raman spectra of DWNTs before (upper curve) and after (lower curve) processing in H₂O₂ vapor.

FIG. 7 shows broken carbon shells in CNTs after being purified by a process according to embodiments of the invention.

### DETAILED DESCRIPTION

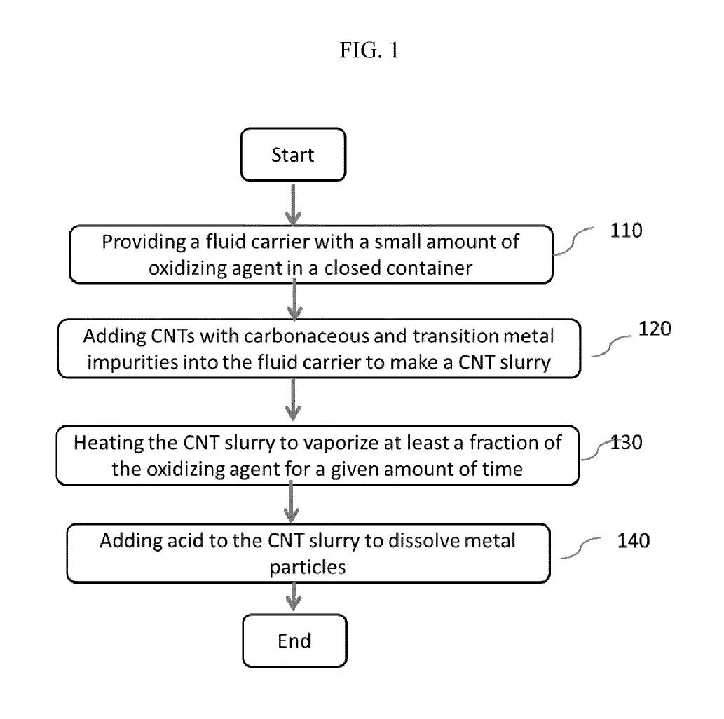

Referring to FIG. 1, in some embodiments of the invention, a process of purifying carbon nanotubes (CNTs) includes providing a relatively small amount of an oxidizing solution including a fluid carrier and an oxidizing agent in a closed container (110), and adding CNTs with carbonaceous and transition metal impurities into the oxidizing solution to produce a CNT slurry (120). The CNT slurry is then heated to an elevated temperature (130) for a specified amount of time to vaporize at least a fraction of the oxidizing agent. Next, a suitable amount of acid is added to the slurry (140) to wash off metal particles from the CNTs.

Any suitable oxidizing agent may be used, nonlimiting examples of which include H₂O₂ and HNO₃. The oxidizing agent may be diluted by a fluid carrier, such as water. When diluting the oxidizing agent with a fluid diluent to form an oxidizing solution, the amount of the oxidizing solution may be about 5 wt % to about 70 wt % based on the weight of the fluid carrier, and in some embodiments about 10 wt % to about 50 wt % based on the weight of the fluid carrier. For example, when the fluid carrier is water, the oxidizing solution may contain about 5 wt % to about 35 wt % of an H₂O₂ oxidizer. Alternatively, in some embodiments, when the fluid carrier is water, the oxidizing solution may contain about 10 wt % to about 68 wt % of an HNO₃ oxidizer.

The volume of the liquids making up the oxidizing solution, i.e., the fluid carrier plus the oxidizing agent, is a fraction of the volume of the container in which the oxidizing solution and CNTs are place. In some embodiments, the volume of the oxidizing solution in the container can be about 10 vol % to about 40 vol % of the container.

The ratio of the CNTs to the oxidizing agent in the oxidizing solution can be from about 1000:1 to about 2:1 by weight, for example, 10:1 to about 50:1 by weight. For example, the CNT slurry may contain about 1 to about 50 grams of CNTs per 1 liter of the oxidizing solution.

The CNT slurry is then heated at an elevated temperature for a suitable amount of time. For most CNTs, the elevated temperature is between about 60° C. and about 110° C., and the slurry is held at that temperature for about 30 minutes to about 3 hours. Overall, the range for the elevated temperature should have a high point that is close to the boiling point of the oxidizing agent, and a low point that ensures an adequate amount of vapor and efficient oxidizing kinetics. While held at the elevated temperature, the oxidizing agent vaporizes and the vapor phase reaches a state of equilibrium with the liquid phase. For example, in the case of H₂O₂ with CNTs that contain Fe impurities, the Fe catalyzes the production of reactive radicals such as —OH and —OOH, two oxidants much more powerful than H₂O₂. The reactive radicals then attack the carbonaceous impurities around the CNTs as well as those surrounding the Fe particles to produce partly or fully dissolved or hydroxylized products that can be removed or separated from the CNT array. The Fe particles are exposed as a result, and the exposed Fe particles can then be washed off with another suitable acid.

Nonlimiting examples of suitable acids include HNO₃ and HCl. In some embodiments, for example, an excess amount of acid is used with respect to the metals, and this amount may be calculated using thermogravimetric analysis measurements, which calculations and measurement methods are known to those of ordinary skill in the art. For example, for 500 mg of CNTs, a 50 mL solution of 1.0 M HNO₃ or 1.0 M HCl may be added to remove the metal impurities.

Apart from the desired reactions for removing impurities, the dissociation of H₂O₂ may be the only other possible reaction. However, since the dissociation reaction is kinetically slow at temperatures lower than 110° C., the process can be well controlled. The heat treatment is able to partially or completely remove metal nanoparticles surrounding the carbon nanotubes. Therefore, the follow-up acid-washing can be done under mild conditions, i.e., non-oxidative or weakly oxidative conditions. For example, in some embodiments, the mild conditions may include a 1.0 M acidic solution, or 1.0 M HCl or less than 3.0 M HNO₃

The purification process according to embodiments of the present invention is time- and cost-effective. Unlike solution-processible purification of CNTs using H₂O₂, which takes about 3 days to achieve a purity of about 97.6%, the methods according to embodiments of the present invention achieve more than 99% purity in about 2 hours. Furthermore, the required amount of H₂O₂, which is an expensive, environmentally aggressive chemical, is greatly minimized by making the best usage of vapor. Indeed, starting with 20 mL of liquid H₂O₂ confined in a 3-liter flask, the vapor works efficiently to purify 500 mg of CNTs. Since H₂O₂ vapor is a relatively moderate oxidizer, the process according to embodiments of the present invention is also non-invasiveness and has high yield. Furthermore, after separation from the purified CNT samples, the H₂O₂ can be recycled, thereby reducing the environmental footprint.

The process according to embodiments of the present invention is applicable for different kinds of CNTs, setting it apart from conventional methods, which only work well with CNT arrays. CNTs, especially super-long CNTs (i.e., CNTs with lengths on the millimeter scale), are prone to form skeins due to their super-hydrophobic surface. Few methods have been reported that can efficiently purify millimeter-long CNTs, due largely to the technical difficulties in dispersing them in a suitable medium. The methods according to embodiments of this invention work well even with super-long CNTs. Indeed, the methods according to embodiments of the present invention work well for double-walled CNTs measuring 0.5 mm to 5 mm in length.

Also, compared to conventional methods, the process according to embodiments of the present invention tactically circumvents the issue of oxygen by virtue of the self-catalytic chemical reaction; its features, such as operating at low temperature and time-effectiveness, are additionally useful. Indeed, the whole procedure for purifying gram-scale CNTs according to embodiments of the present invention is completed in an open system. That is, the dissociation reaction of H₂O₂, if any, is negligible and makes an insignificant difference in the purification of the CNTs. Overall, in comparison to conventional methods, the processes according to embodiments of the present invention are significantly simplified and operate under mild conditions.

Without being bound by any particular theory, it is believed that some of the advantages of the methods according to embodiments of the present invention are partially associated with heating the CNT slurry with an oxidizing agent to vaporize the oxidizing agent in a closed container with a specified volume, where the H₂O₂ (for example) vapor is in contact with its liquid phase, and the two phases are brought to a state of equilibrium. Compared with liquid H₂O₂, individual molecules of the H₂O₂ vapor move much faster with more free space so as to enable more efficient attack of impurities around the CNTs. Importantly, in view of the lever rule, the liquid phase in a H₂O₂-H₂O binary equilibrium system can conceptually be viewed as concentrated H₂O₂ relative to its single-phase aqueous solution. This physichemical property can enhance the etching kinetics of H₂O₂, which depends on its concentration. In addition, the chemical reactions of the purification of carbonaceous impurities produce gases at the surfaces of the CNTs, disperse the CNT aggregations through the bubbling of the gases, and therefore create larger contact surface area for further purification reactions. It is noteworthy that in solution-processing of CNTs, individual nanotubes often strongly stick to each other and pose a challenge in chemical processing involving CNTs.

Some of the advantages of the methods according to embodiments of the present invention are also believed to be partially associated with the reaction mechanism being a self-catalytic chemical reaction involving transition-metal nanoparticles, which are a type of impurities in CNTs. The chemical etching is based on a region-specific reaction with high selectivity toward removing metallic impurities. Even under mild conditions, the metal nanoparticles are able to expedite the decomposition of H₂O₂, yielding OH radicals (—OH). Consequently, not only are metallic impurities selectively removed by their oxidation, but also, the as-yielded OH radicals can largely eliminate amorphous carbon surrounding them and elsewhere. Likewise, the etching of amorphous carbon is also highly selective against nanotubes, which is especially true under the conditions applied.

The processes according to embodiments of the present invention are suitable for industrial applications due to their time- and cost-effectiveness. Although oxidizers such as H₂O₂, HNO₃, H₂SO₄, and their mixtures are commonly used in the chemical industry, ineffective handling of these chemicals may cause large environmental footprints that otherwise can be circumvented. Usage of these chemicals in the whole procedure is greatly reduced when the reaction is based on the vapor phase. Their residues on CNTs can be efficiently removed by their decomposition under appropriate conditions.

By tactically using the ability of vapors for selectively etching impurities such as transition metal nanoparticles, the methods according to embodiments of the present invention afford a non-invasive, additive-free means for purifying CNTs. To date, most chemical methods of purifying CNTs irreversibly change the conjugated crystalline structure somewhat, thus changing the nature of the CNTs. Such modified CNTs often suffer from low conductivity, and the modified molecules may impede electron transfer and mass diffusion in heterogeneous CNT-based reactions. Unlike such conventional methods, the methods according to embodiments of the present invention surprisingly improve the quality of CNTs by selectively removing impurities. It is believed that the impurities, such as transition metals and certain carbonaceous materials, have much lower tolerances than the CNTs to the OH and OOH free radicals (—OH and —OOH), the intermediate products of the Fenton reaction between H₂O₂ and the transition metal. This reaction mechanism leads to the selectivity and non-invasiveness of the methods according to embodiments of the present invention.

The chemical or electrochemical processes in conventional methods lead to oxidation of the CNTs as well as the impurities, and consequently, all the carbon components are terminated by quinone- and/or carboxyl-groups and defects. In contrast, radical reactions involving —OH or —OOH can purify CNTs with the following features:

(1) More detectable oxygen-containing groups that are fundamentally different from quinone- and/or carboxyl-groups are present in the final product. Additional stable radicals such as peroxy radicals (—RO₂) may form at the end of the nanotubes through the following reactions:

OH+Cn−RH→H₂O+Cn−R

Cn−R—+O₂→Cn−RO₂

(2) H₂O₂ vapor is not able to completely remove amorphous carbon. Consequently, in as-purified products, the functional groups (including C═O and COOH groups, if any) are predominantly attached to amorphous carbon, instead of CNTs; and

(3) The methods according to embodiments of the present invention are efficient in removing substantially all carbon-coated metals. As used herein, the term “substantially” is used as a term of approximation and not a term of degree, and is intended to account for the inherent deviations in measured or calculated values that would be recognized by those of ordinary skill in the art. In particular, as used herein, “remove substantially all carbon-coated metals” refers to the removal of most of the carbon-coated metals from the CNTs, and that if any trace amounts of the metals remain after the process, those amounts are negligible. In conventional processes, carbon-coated metals and/or metal oxides are extremely difficult to remove because of the chemical- and physical-stability and protective role of the carbon coating. However, in the methods according to embodiments of the present invention, as the carbon coating surrounding the metallic impurities can be cracked by chemical reaction with free radicals, those impurities are susceptible to acid-washing, significantly facilitating their purification. This is true for most metals/metal oxides that are used as catalysts in CNT synthesis, such as Fe, Co, Ni, Pd, MgO, MnO, and their adducts and part of the amorphous carbons. The as-purified product in turn contains broken carbon spheres or shells with free radicals attached after the enclosed metal nanoparticles have been washed off More new functional groups may have been produced as a result of the radical reactions at the broken carbon spheres, especially around the openings than at the CNTs and other carbonaceous materials.

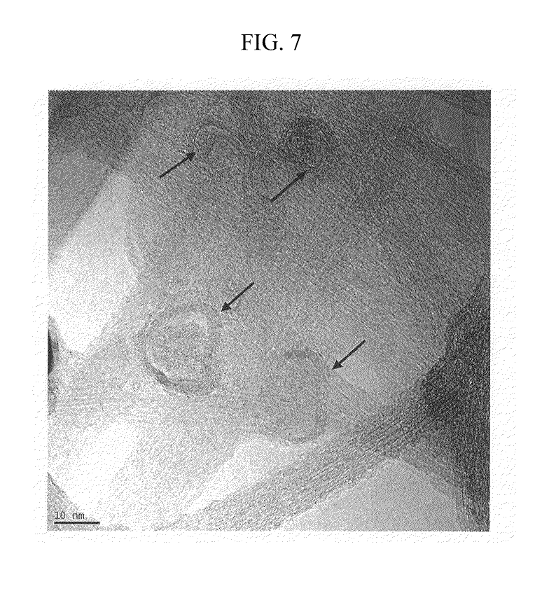

FIG. 7 shows broken carbon spheres as a result of the purification process according to embodiments of the present invention. Those are most likely carbonaceous materials surrounding the metal impurities that were cracked open by the free radicals and were left behind after the exposed metal particles were washed off by the second acid.

To summarize, the heating of the CNT slurry involves a free radical process in which vaporized oxidizing agent produces free radicals that react with the CNTs to produce functionalized metal nanoparticles that can be subsequently dissolved by an acid. The vapor-processed free radicals react with the CNTs by attaching free radicals to the nanoparticles to produce the functionalized nanoparticles, which are then dissolved by the acid. The CNTs initially have metal nanoparticles attached to them as impurities, and those impurities are removed by the vaporized oxidizing agent, such as H₂O₂, which cracks open the carbon shell (not the CNT) of the metal nanoparticles and attaches the free radicals generated from the H₂O₂ to the carbon shell. Then, by adding a dilute acid the functionalized metal nanoparticles are more easily dissolved and then removed by filtration.

The following Examples are presented for illustrative purposes only and do not limit the scope of the present invention.

### Example 1

20 mL H₂O₂ were diluted by 50 mL H₂O to make a 10 wt % oxidizing solution. 500 mg millimeter-long CNTs synthesized with Fe particles as the catalyst were then added to 50 mL of the oxidizing solution in a 3-liter flask to make a CNT slurry. The slurry was then heated at 85° C. and held there for 2 hours. The heating procedure can include the use of a heater with a thermocouple set at 85° C. followed by oil-bath heating of the slurry until the slurry reached the set-point value. Alternatively, the slurry can be placed in an oil bath at room temperature and then heated to 85° C. 500 mL of 1M HNO₃ was added to the slurry at the end of the 2 hours. Lastly, the CNT slurry was filtered using porous filter paper, and the CNTs were rinsed with copious amounts of water and dried. 5 micron pore size filter paper was used for collecting the super-long CNTs in this example.

However, it is understood by those of ordinary skill in the art that the pore size of the filter paper will be chosen based on the dimension of the CNTs to be collected. For most CNTs, a 0.45 micron pore size is sufficient.

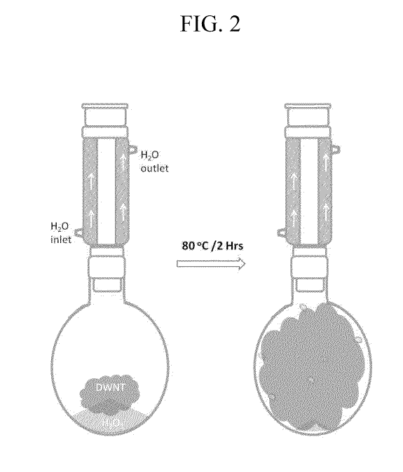

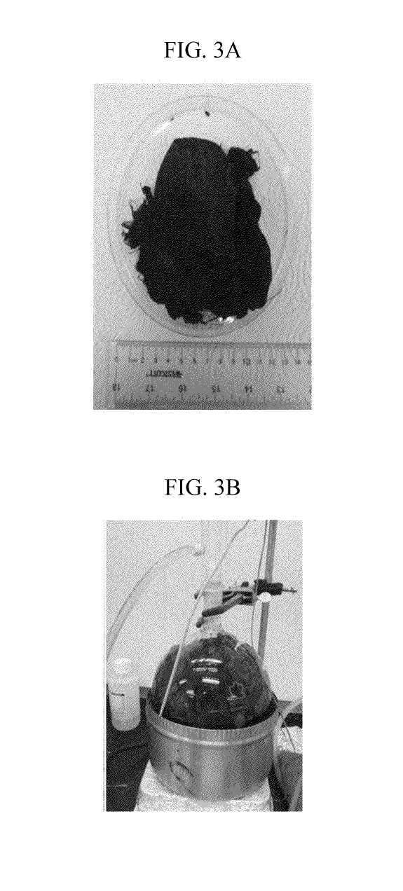

FIG. 2 depicts a schematic of a glassware setup useful in the vapor-based processing of DWNTs, and the volume change of DWNTs upon heating. FIGS. 3A and B are photographic images of pristine- and in-process-DWNTs, showing that H₂O₂ vapor caused the DWNTs to expand to possibly the full size of the flask. During the reaction, a significant amount of bubbles was generated at the nanotubes, which caused them to scatter and expand to the same size as the flask (3 L). This can be mainly attributed to Fe-catalytic destruction of the carbon coating to produce CO₂ via Fenton's reaction.

Although 30 wt % H₂O₂ itself may be insufficient to attack the carbon coatings under the conditions in this example, iron can help produce reactive radicals such as —OH and —OOH, which are both more powerful oxidants than H₂O₂. The etching of carbon can be further enhanced by expediting the production rate of the radicals.

Besides H₂O₂ as used in this example, many oxidizing agents, such as, for example, HNO₃, can be used in the vapor-processible purification of DWNTs.

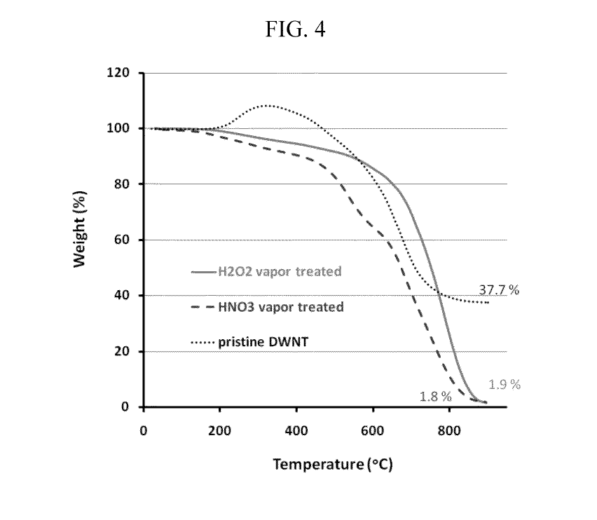

The efficacy of the purification methods described herein was studied by performing Thermogravimetric analyses (TGA) for both pristine- and as-purified-DWNTs, and comparing their purities by the percentage of residues. The TGA curves shown in FIG. 4 demonstrate that the H₂O₂-purified DWNTs exhibited a hysteretic burning-off, while the HNO₃-vapor treatment caused a downshift by about 40° C., compared with the pristine DWNTs. This comparison revealed that the conjugated structure of the nanotubes survived the vapor-based processes. This is particularly true for H₂O₂. Furthermore, the percentage of residues can be attributed to residual metal impurities, the balance of which can then be attributed to the amount of CNTs. The purity is then greater than 98.2 wt % of DWNTs after the HNO₃- or H₂O₂-vapor treatment. This value, compared with 72.3 wt % of the pristine DWNTs, suggested a significant improvement in the purity of the DWNTs by the methods according to embodiments of the present invention.

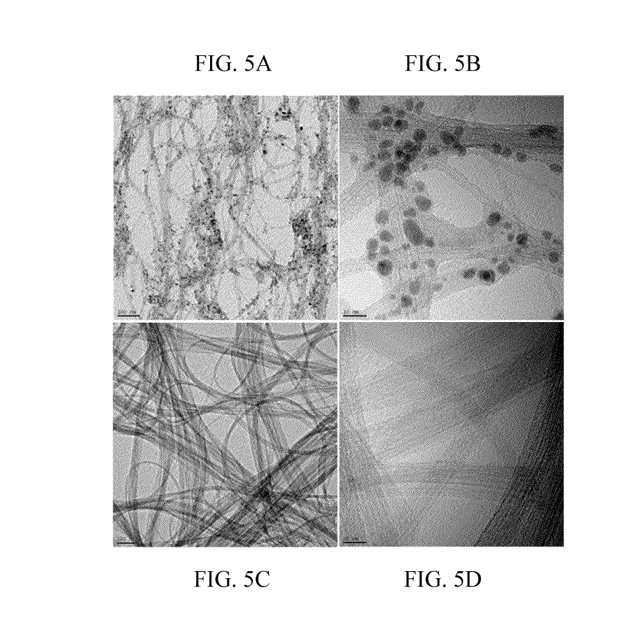

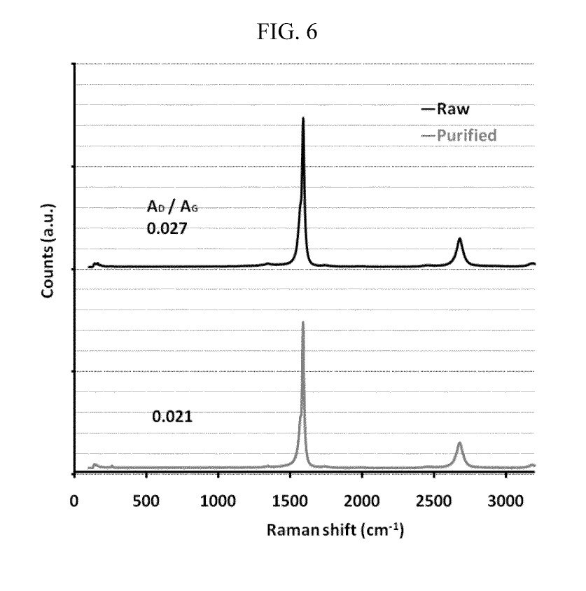

FIGS. 5A to 5D show the corresponding transmission electron microscope (TEM) images of the DWNTs before and after processing in H₂O₂. For the pristine sample, a significant loading of dark spots with higher contrast than nanotubes were observed. As the contrast in darkness in the TEM images is linearly related to the atomic weight to the power of 1.7, and combined with the fact that Fe nanoparticles were used to synthesize the DWNTs, the dark spots can be attributed to the Fe nanoparticles. The high-magnification TEM image (FIG. 5B) shows carbon nanocoatings surrounding the Fe nanoparticles, which made it a challenge to remove the Fe nanoparticles. In contrast, subjecting the pristine DWNTs to the H₂O₂-vapor treatment led to well-defined tubular structures with a clean surface (FIGS. 5C and D). A closer TEM-image (FIG. 5C) showed distinct intrinsic sidewalls of the nanotubes. These images confirmed that the method according to embodiments of the present invention has purifies DWNTs with high efficiency. The improved quality of the as-purified DWNTs was confirmed by comparing their Raman spectrum to that of pristine DWNTs. As shown in the inset in FIG. 6, the ratio of the integrated amplitude between the D- and G-band, AD/AG, decreased by 22% after processing the DWNTs in H₂O₂ vapor, pointing to a dramatic drop in the amount of impurities.

While certain embodiments of the present invention have been shown and described, it is understood by those of ordinary skill in the art that various modifications can be made to the described embodiments without departing from the spirit and scope of the present invention, as defined in the following claims.

1. A process for purifying carbon nanotubes, comprising:
mixing a fluid carrier with an oxidizing agent to form an oxidizing solution;
adding the oxidizing solution to a closed container such that the oxidizing solution makes up a fraction of the volume of the container;
adding carbon nanotubes containing transition metal nanoparticles and carbonaceous impurities to the oxidizing solution to form a carbon nanotube slurry;
heating the carbon nanotube slurry at an elevated temperature to vaporize at least a portion of the oxidizing agent, the elevated temperature not exceeding 110° C.; and
adding acid to the heated carbon nanotube slurry to dissolve transition metal particles.

2. The process of claim 1, wherein the oxidizing agent is H₂O₂ or HNO₃.

3. The process of claim 1, wherein the oxidizing agent is H₂O₂.

4. The process of claim 3, wherein the vaporized H₂O₂ forms hydroxyl free radicals through a self-catalytic reaction with the transition metal nanoparticles.

5. The process of claim 1, wherein the carbon nanotubes added to the oxidizing solution are randomly oriented.

6. The process of claim 1, further comprising:
filtering the heated carbon nanotube slurry to collect processed carbon nanotubes; and
rinsing the processed carbon nanotubes to yield purified carbon nanotubes.

7. The process of claim 6, wherein the purified carbon nanotubes contain broken carbon shells with hydroxyl functional groups, and additional functional groups located around the openings of the broken carbon shells.

8. The process of claim 1, wherein the amount of oxidizing solution is about 1 liter for about 1 to about 50 grams of carbon nanotubes.

9. The process of claim 1, wherein the vaporized oxidizing agent produces reactive free radicals that react with the impurities in the carbon nanotubes to produce functionalized transition metal nanoparticles that are dissolved by the acid.

10. The process of claim 1, wherein the elevated temperature is about 60° C. to about 110° C.

11. The process of claim 1, wherein a weight ratio of the carbon nanotubes to the oxidizing agent is about 10:1 to about 50:1.

12. The process of claim 1, wherein an amount of the oxidizing agent in the oxidizing solution is about 5 wt % to about 70 wt %.

13. The process of claim 1, wherein an amount of the oxidizing agent in the oxidizing solution is about 10 wt % to about 50 wt %.

14. The process of claim 1, wherein the oxidizing agent is H₂O₂, and the amount of H₂O₂ in the oxidizing solution is about 5 wt % to about 35 wt %.

15. The process of claim 1, wherein the oxidizing agent is HNO₃, and the amount of HNO₃ in the oxidizing solution is about 10 wt % to about 68 wt %.

16. The process of claim 1, wherein the fluid carrier comprises water.

17. The process of claim 1, wherein the heating the carbon nanotube slurry comprises holding the carbon nanotube slurry at the elevated temperature for about 30 minutes to about 3 hours.

18. The process of claim 1, wherein the acid comprises HNO₃, HCl, or a mixture thereof.

19. The process of claim 1, wherein the acid added to the heated carbon nanotube slurry comprises a 1 M acid solution.
